(19) United States
(12) Patent Application Publication
(10) Pub. No.: US 2023/0363487 A1
(43) Pub. Date: Nov. 16, 2023

(54) SELF-POWERED LUMINOUS DEVICE AND SOLE STRUCTURE COMPRISING SAID LUMINOUS DEVICE

(71) Applicant: GEOX S.p.A., Montebelluna (TV) (IT)

(72) Inventors: Mario MORETTI POLEGATO, Montebelluna (TV) (IT); Giuliano GALLO, Montebelluna (TV) (IT)

(73) Assignee: GEOX S.p.A., Montebelluna (TV) (IT)

(21) Appl. No.: 18/044,807

(22) PCT Filed: Oct. 4, 2021
(86) PCT No.: PCT/IB2021/059082

§ 371 Date: Mar. 10, 2023

(30) Foreign Application Priority Data
Oct. 6, 2020 (IT) 102020000023479

(51) Int. Cl. A43B 3/42; A43B 3/36; H02N 2/18

(52) U.S. Cl. CPC A43B 3/42; A43B 3/36; H02N 2/186

(57) ABSTRACT

The invention relates to a sole structure (1) for luminous footwear, comprising a sole (2) and a self-powered luminous device (3) combined with the sole, wherein the luminous device comprises: n light sources (5) with n>2, a piezoelectric system (6) comprising at least one supporting layer (8) and at least one first piezoelectric layer (9) combined with each other, and connecting means (7) to electrically connect the piezoelectric system to the light sources comprising a first electric cable (10) and a second electric cable (11) which have respective first ends (12, 13) electrically connected to the piezoelectric system, wherein n-m light sources (14, 15), with m>1, are arranged in the luminous device with a given electrical polarity, and m light sources (16) are arranged in the luminous device with an opposite electrical polarity with respect to the given electrical polarity, and wherein the luminous device is without electrical battery.

### FIELD OF THE INVENTION

The invention relates to a self-powered luminous device adapted to illuminate the environment surrounding a user of the self-powered luminous device and/or to make a user more visible to an external observer.

The invention further relates to a sole structure for luminous footwear comprising the aforesaid self-powered luminous device and luminous footwear comprising the aforesaid sole structure.

### STATE OF THE ART

Nowadays, footwear items equipped with luminous devices comprising light sources, for example LEDs (Light Emitting Diodes), optical fibers, electroluminescent ducts and the like, powered by disposable or rechargeable batteries, are known.

Such footwear items have the drawback of battery disposal, whether throw-away or rechargeable batteries.

Even rechargeable batteries, indeed, after a certain number of charging and discharging cycles are subject to deterioration that makes them unusable.

In order to at least partially overcome the aforesaid drawback, the known art has provided alternative solutions which involve the use of luminous devices able to self-power themselves through the so-called “harvesters” which exploit the movement and, in particular, the impact with the ground of the user's feet (piezoelectric harvesters) or the variation of the magnetic field flux (inductive harvesters).

The document WO 91/13288 describes, for example, luminous footwear whose sole incorporates an element constituted by a piezoelectric polymer layer which, as a result of a stress generated by an impact, generates an electrical signal able to activate a circuit connected to a battery that powers a light source constituted by LED or optical fibers, or a loudspeaker. However, this solution as well requires the use of a battery and therefore suffers from the same drawback mentioned above.

A further drawback is due to the use of a piezoelectric polymer, which is one of the most expensive solutions currently available and therefore particularly affects the cost of the footwear, bearing in mind among other things that the cost of the piezoelectric polymer layer far exceeds the cost of the sole itself.

Considering that most of the luminous footwear is aimed at children, for whom the useful life of the footwear, and therefore of the piezoelectric polymer, is very limited, both because it is subjected to heavy use and because the foot's size grows quickly, the economic disadvantage of such a solution is even more evident.

U.S. Pat. No. 4,748,366 describes luminous footwear having a sole inside which a piezoelectric element is placed between two electrodes, wherein the piezoelectric element is connected by wires to a light source assembled to an upper, visible portion of the footwear.

Also in this case, the piezoelectric element can consist of a piezoelectric polymer, resulting in a drawback due to its use, as set forth above.

Moreover, if the stress reaching the piezoelectric element does not exceed a certain threshold value, it is possible, inconveniently, that the solution described in U.S. Pat. No. 4,748,366 does not allow the light source to be turned on. This possibility is not unlikely, especially in the case of footwear for children, who may find it unpleasant if the light source is not turned on even though the footwear has impacted the ground.

### SUMMARY OF THE INVENTION

The technical problem underlying the present invention was to provide luminous footwear with structural and/or functional features so as to overcome one or more of the drawbacks mentioned above with reference to the known art.

According to the invention the aforesaid problem is solved by a self-powered luminous device comprising:
n light sources, with n≥2,
a piezoelectric system comprising at least one supporting layer and at least one first piezoelectric layer combined with each other, and
connecting means to electrically connect the aforesaid piezoelectric system to the aforesaid light sources, wherein the aforesaid connecting means comprise a first electric cable and a second electric cable which have respective first ends electrically connected to the aforesaid piezoelectric system,
which is characterized in that n-m light sources, with m≥1, are arranged in the aforesaid luminous device with a given electrical polarity and m light sources are arranged in the aforesaid luminous device with an opposite electrical polarity with respect to the aforesaid given electrical polarity, and in that
the aforesaid luminous device is without electrical battery or cell.

In practice, according to the invention, the arrangement of the light source(s) m with opposite electrical polarity with respect to the light source(s) n-m results in them being turned on when the potential difference generated by the piezoelectric system has opposite sign with respect to the potential difference that causes the light source(s) n-m to be turned on.

In other words, according to the present invention, the potential difference generated by the piezoelectric system can be exploited to turn on the light sources both when the piezoelectric system undergoes an elastic mechanical stress, and therefore the potential difference at the ends of the piezoelectric system has positive sign, for example, and when the piezoelectric system returns to the initial configuration once the mechanical stress is over, and therefore the potential difference at the ends of the piezoelectric system has negative sign, for example. This is advantageous in that it allows the electric power produced to be used even after the mechanical stress the piezoelectric system is subjected to has ceased.

The above is consistent with the definition of electrical polarity, which is generally defined as the property of an electrified body or apparatus to have electrical charges of positive and negative signs at the opposite ends or on two electrodes.

Preferably, the aforesaid at least one first piezoelectric layer is made of a ceramic material, more preferably a ceramic material selected from the group comprising lead zirconate titanate (PZT) and aluminum nitride (AlN) crystals.

Preferably the aforesaid at least one supporting layer is made of a metal material, more preferably brass.

In compliance with the above and according to some embodiments of the invention, the aforesaid first ends of the aforesaid first electric cable and the aforesaid second electric cable are electrically connected to the aforesaid at least one supporting layer and to the aforesaid at least one first piezoelectric layer, respectively.

Preferably, the aforesaid connecting means comprise an elastic element interposed between the aforesaid at least one first piezoelectric layer and the first end of the aforesaid second electric cable, wherein, more preferably, the aforesaid elastic element is a metal spring.

In compliance with the above and according to some embodiments of the invention, the aforesaid piezoelectric system comprises a second piezoelectric layer combined with the aforesaid at least one supporting layer on the opposite side with respect to the aforesaid at least one first piezoelectric layer.

The aforesaid second piezoelectric layer is preferably the same as the aforesaid at least one first piezoelectric layer and like the latter is in practice constrained to the aforesaid at least one supporting layer, thereby forming a sandwich structure.

Preferably, the aforesaid connecting means comprise a third electric cable, wherein the aforesaid third electric cable is extended between the aforesaid at least one first piezoelectric layer—more preferably at the electrical connection of the aforesaid first end of the aforesaid second electric cable—and the aforesaid second piezoelectric layer, or wherein the aforesaid third electric cable branches off from the aforesaid second electric cable and has a respective first end electrically connected to the aforesaid second piezoelectric layer.

Therefore, the aforesaid third electric cable may be considered as a further length or segment of the aforesaid second electric cable, which may be included between the aforesaid at least one first piezoelectric layer and the aforesaid second piezoelectric layer, preferably between the aforesaid first end of the aforesaid second electric cable and the aforesaid second piezoelectric layer, possibly passing through the aforesaid at least one supporting layer, in practice as an extension of the aforesaid second electric cable, or which may be included between a portion of the aforesaid second electric cable distal from the aforesaid at least one first piezoelectric layer and the aforesaid second piezoelectric layer, in practice as a branch of the aforesaid second electric cable.

Preferably, the aforesaid connecting means comprise a conducting element in contact with both the aforesaid at least one first piezoelectric layer and the aforesaid second piezoelectric layer, and an insulating element interposed between the aforesaid conducting element and the aforesaid at least one supporting layer, wherein the aforesaid first ends of the aforesaid first electric cable and the aforesaid second electric cable are combined with the aforesaid at least one supporting layer and the aforesaid conducting element, respectively.

The aforesaid insulating element, whose extent is preferably minimal with respect to the extent of the aforesaid conducting element which, on the other end, is preferably maximal with respect to the piezoelectric layers, is intended to prevent the conducting element from contacting the aforesaid supporting layer of the piezoelectric system.

This way, the aforesaid at least one first piezoelectric layer and the aforesaid second piezoelectric layer are arranged in parallel, i.e., they have concordant polarization.

In compliance with the above and according to some embodiments of the invention, the aforesaid first ends of both the aforesaid first electric cable and the aforesaid second electric cable are electrically connected to the aforesaid second piezoelectric layer and to the aforesaid at least one first piezoelectric layer, respectively, and preferably the aforesaid connecting means comprise a first conducting element and a second conducting element which are interposed between the aforesaid at least one first piezoelectric layer and the first end of the aforesaid second electric cable and between the aforesaid second piezoelectric layer and the first end of the aforesaid first electric cable, respectively.

The aforesaid first conducting element and second conducting element are placed, in practice, above and in contact with the aforesaid at least one first piezoelectric layer and the aforesaid second piezoelectric layer, respectively, while they are electrically insulated from each other so as to not create a short circuit.

In this case, the aforesaid at least one first piezoelectric layer and the aforesaid second piezoelectric layer are arranged in series, i.e., they have discordant polarization.

According to the invention, in all of the above embodiments, the aforesaid luminous device preferably comprises a first element located on a first side of the aforesaid piezoelectric system, and a second element located on a second side of the aforesaid piezoelectric system opposite the aforesaid first side, wherein the aforesaid first element and the aforesaid second element are substantially in contact with the aforesaid piezoelectric system, wherein the aforesaid first element and the aforesaid second element constitute a support for the piezoelectric system and a striker for transmitting stresses to the piezoelectric system, respectively.

Preferably, at least one of the aforesaid first element and the aforesaid second element comprises at least two portions having hardness different from each other, and more preferably both the aforesaid first element and the aforesaid second element comprise at least two portions having hardness different from each other.

According to some embodiments of the invention, the aforesaid at least two portions are one inside the other, i.e. one is a central portion partially or completely surrounded by the other portion or peripheral portion, and preferably they are substantially circular and concentric with each other, whereas according to some other embodiments the aforesaid at least two portions have shapes complementary to each other and are arranged one above the other, one portion having a convex side, the other portion having a concave side in contact with the aforesaid convex side.

According to some embodiments of the invention, at least one of the aforesaid first element and the aforesaid second element preferably comprises a central portion and a pair of side portions between which the aforesaid central portion is included, wherein the aforesaid central portion and the aforesaid side portions have hardness different from each other.

Preferably, at least one of the aforesaid first element and the aforesaid second element comprises a pair of peripheral portions between which the aforesaid pair of side portions is included, wherein the aforesaid peripheral portions, the aforesaid side portions and the aforesaid central portion have hardness different from each other.

Preferably, the aforesaid central portion of the aforesaid second element has a substantially truncated-cone or spherical-cap profile, on the side of the aforesaid second element substantially in contact with the aforesaid piezoelectric system.

Preferably, the aforesaid portions having hardness different from each other have surfaces in mutual contact with each other inclined with respect to an axis perpendicular to the aforesaid piezoelectric system, preferably by an angle between about 2° and about 30°.

Preferably, in all embodiments of the present invention, the greater or lesser hardness of the aforesaid at least two portions having hardness different from each other is reversed between the aforesaid first element and the aforesaid second element.

Therefore, in compliance with the above and according to the present invention, in the aforesaid first element and/or the aforesaid second element comprising at least two portions arranged one above the other, the aforesaid portion having higher hardness is preferably arranged distal from the aforesaid piezoelectric system and the aforesaid portion having lower hardness is preferably arranged proximal to the aforesaid piezoelectric system, wherein in the aforesaid first element and/or the aforesaid second element, the aforesaid portion with lower hardness preferably consists of ethylene vinyl acetate (EVA) with hardness preferably between 40 and 65 Asker C, wherein in the aforesaid first element and/or the aforesaid second element, the aforesaid portion with higher hardness preferably consists of polyamide, ethylene vinyl acetate (EVA) or rubber preferably with hardness of at least about 75 Shore A.

Furthermore, in compliance with the above and according to the present invention, in the embodiments in which the aforesaid first element and/or the aforesaid second element comprise/s more than two portions, preferably the aforesaid central portion of the aforesaid first element has hardness lower than the hardness of the aforesaid side portions and, more preferably, the aforesaid side portions have hardness lower than the hardness of the aforesaid peripheral portions.

And again, in compliance with the above and according to the present invention, preferably the aforesaid central portion of the aforesaid second element has hardness higher than the hardness of the aforesaid side portions and, more preferably, the latter have hardness higher than the hardness of the aforesaid peripheral portions.

Preferably, the aforesaid first element and the aforesaid second element have the same dimensions, and more preferably the width of aforesaid side portions of the aforesaid second element is greater than the width of the aforesaid side portions of the aforesaid first element, wherein even more preferably each side portion of the aforesaid second element is wider than each side portion of the aforesaid first element by an amount d≥1 mm.

Preferably, the thickness of the aforesaid first element and/or the thickness of the aforesaid second element is at least about 1.5 mm.

In embodiments in which the aforesaid first element and/or the aforesaid second element comprise a central portion included between a pair of side portions, the central portion of the aforesaid first element and/or the side portions of the aforesaid second element preferably consist of ethylene vinyl acetate (EVA) having hardness preferably between 40 and 65 Asker C, and the side portions of the aforesaid first element and/or the central portion of the aforesaid second element preferably consist of polyamide, ethylene vinyl acetate (EVA) or rubber having hardness of at least about 75 Shore A.

In embodiments in which the aforesaid first element and/or the aforesaid second element comprise, not only a central portion included between a pair of side portions but also a pair of peripheral portions between which the aforesaid side portions are included, the central portion of the aforesaid first element and/or the peripheral portions of the aforesaid second element preferably consist of ethylene vinyl acetate (EVA) having hardness between 40 and 65 Asker C, the peripheral portions of the aforesaid first element and/or the central portion of the aforesaid second element preferably consist of polyamide, ethylene vinyl acetate (EVA) or rubber having hardness at least about 75 Shore A, and the side portions of the aforesaid first element and/or the side portions of the aforesaid second element preferably consist of polyamide, ethylene vinyl acetate (EVA) or rubber having hardness intermediate between the hardness of the respective peripheral portions and the hardness of the respective central portion.

Preferably in the aforesaid piezoelectric system, the aforesaid at least one supporting layer has greater dimensions, i.e. width and/or length, than the aforesaid at least one first piezoelectric layer.

Preferably, the aforesaid luminous device comprises at least one support combined with either the aforesaid first element or the aforesaid second element, and more preferably the aforesaid luminous device comprises a first support and a second support with which the aforesaid first element and the aforesaid second element are combined, respectively.

Preferably the number of the aforesaid light sources is greater than or equal to three (n≥3).

Preferably the aforesaid light sources are LEDs (Light Emitting Diode).

According to the invention, the aforesaid problem is further solved by a sole structure for luminous footwear comprising a sole and at least one luminous device of the aforesaid type combined with the aforesaid sole.

According to the above, the aforesaid problem is further solved by luminous footwear comprising the aforesaid sole structure and an upper combined with the aforesaid sole.

According to the invention, the aforesaid light sources may be placed all at the aforesaid sole, all at the aforesaid upper, or they may be split partly at the aforesaid sole and partly at the aforesaid upper.

### BRIEF DESCRIPTION OF THE FIGURES

Further characteristics and advantages of the invention will be better highlighted by considering the following detailed description of some preferred, but not exclusive, embodiments illustrated by way of example only and without limitations, with the aid of the accompanying drawings, in which:

FIG. 1 schematically depicts a sole structure for luminous footwear, comprising a sole and a so-called self-powered luminous device combined with the sole, wherein the luminous device comprises a plurality of light sources, a piezoelectric system and connecting means to electrically connect the piezoelectric system to the light sources, wherein the luminous device is partially shown in separate parts, according to the present invention;

FIG. 2 depicts a wiring diagram of the luminous device of the sole structure of FIG. 1;

FIGS. 3 to 10 schematically show some embodiment variations of some details of the luminous device of the sole structure of FIG. 1, according to the present invention;

FIG. 11 schematically show the operation of the luminous device of the sole structure of FIG. 1, according to the embodiments of FIGS. 3-10;

FIG. 12 schematically shows the piezoelectric system and part of the connecting means of the luminous device of the sole structure of FIG. 1, according to an embodiment variation of the invention;

FIG. 13 schematically shows the piezoelectric system of the luminous device of the sole structure of FIG. 1, according to a top view (view a) and a side view (view b), respectively, according to an embodiment variation of the invention;

FIG. 14 shows a partial schematic view of the luminous device of the sole structure of FIG. 1, at rest and during its use, according to an embodiment variation of the invention;

FIG. 15 shows a partial schematic view of the luminous device of the sole structure of FIG. 1, at rest and during its use, according to a further embodiment variation of the invention.

### DETAILED DESCRIPTION OF THE INVENTION

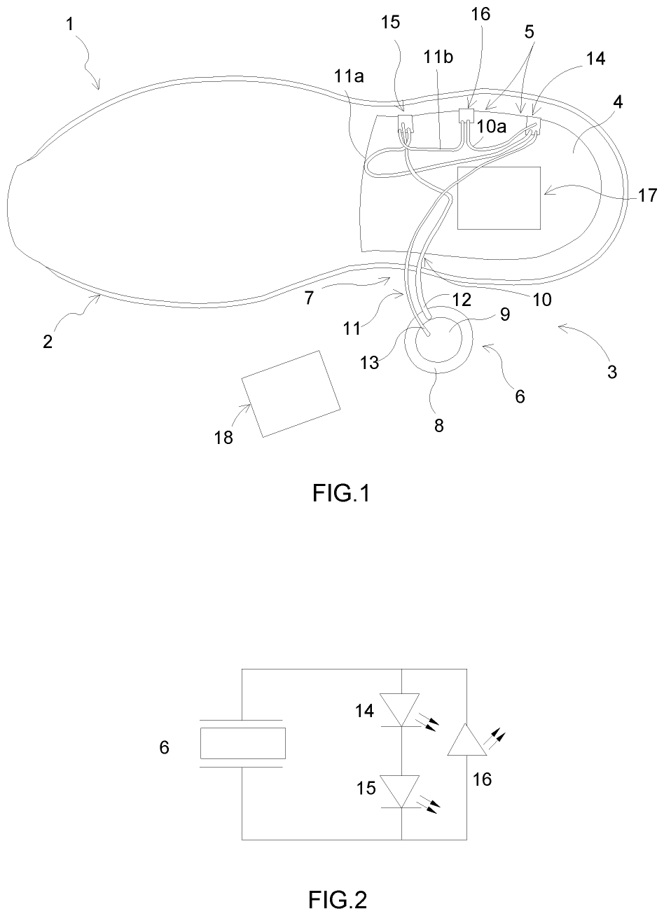

Referring to FIG. 1, a sole structure for luminous footwear according to the present invention is generally denoted by 1.

The sole structure 1 basically comprises a sole 2 and a so-called self-powered luminous device, denoted by 3, combined with the sole 2.

In particular, the sole 2 is provided with a housing 4 where the luminous device 3 is arranged.

Although in the example of FIG. 1 the sole 1 is provided with a single housing and equipped with a single luminous device 3 comprising three light sources altogether denoted by 5, it is to be understood that the sole structure according to the present invention may comprise a luminous device of the aforesaid type having a different number of light sources, for example 2, 4, 5 or more, and/or may comprise more than one luminous device of the aforesaid type. Furthermore, in compliance with the above, the sole 2 which is preferably made of polymeric material according to known techniques may have more than one housing of the aforesaid type.

In compliance with the above, generally speaking, it can therefore be said that the self-powered luminous device according to the present invention comprises n light sources 5 with n≥2, wherein the light sources 5 are preferably LEDs (Light Emitting Diode).

In detail, the luminous device 3 comprises, in addition to the aforesaid light sources 5, a piezoelectric system 6 and connecting means 7 to electrically connect the piezoelectric system 6 to the light sources 5.

The piezoelectric system 6 comprises at least one supporting layer, in the specific case according to the example shown in FIG. 1 a supporting layer denoted by 8, and at least one first piezoelectric layer, in the specific case according to the example shown in FIG. 1 a first piezoelectric layer or simply piezoelectric layer 9, which are combined, i.e. constrained, with each other, while the connecting means 7 comprise a first electric cable 10 and a second electric cable 11 which have respective first ends 12, 13 electrically connected to the piezoelectric system 6.

In particular, still according to the example of FIG. 1, the first end 12 of the first electric cable 10 and the first end 13 of the second electric cable 11 are electrically connected to the supporting layer 8 and to the first piezoelectric layer 9, respectively, while the other ends of the first electric cable and the second electric cable are electrically connected to the aforementioned light sources, as will become more evident hereafter.

As regards in detail the aforesaid piezoelectric system, it must be said that piezoelectricity, as known, is the electric charge that accumulates in certain materials, such as crystals having a structure consisting of microscopic electric dipoles, in response to applied mechanical stress. In a state of rest, the electric dipoles are arranged so that all the faces of the crystal have the same electric potential. When a force is applied from outside, for example by compressing the crystal, the crystal structure is deformed and the condition of electrical neutrality of the material is lost, so that one face of the crystal is negatively charged and the opposite face is positively charged. If the crystal is subjected to tension, the sign of the electric charge of these faces is reversed. Therefore, the crystal behaves like a capacitor to which a potential difference has been applied: if the two faces are connected by an external circuit, an electric current, called piezoelectric current, is generated. The potential difference is a function of the thickness of the crystal, while the current is a function of its surface area. Therefore the energy produced is a function of the volume of the crystal according to the known relation U_{E}=k²U_{M} where U_{E} is the energy produced by U_{M} units of mechanic energy and k is a constant depending on the particular material constituting the crystal, on the geometry thereof and on the type of stress, for example tension, compression, torsion.

Therefore, according to the above, in the luminous device 3, the supporting layer 8 constitutes in practice an electrode (first electrode) or pole (first pole) of the luminous device itself and, preferably, is constituted by a metal material, more preferably brass which is a good electric conductor and is also an inexpensive material having sufficient oxidation resistance.

With regard to the first piezoelectric layer 9, it should be said that it is preferably made of a ceramic material, more preferably a material consisting of titanium lead-zirconate (PZT) crystals or aluminium nitride (AlN). For example, PZT crystals, when deformed by 0.1%, generate a measurable piezoelectricity value.

Crystals of the above type and crystals in general, as known, are characterized by a geometrically regular arrangement of atoms located at the vertices of a structure called crystal lattice, which repeats in the three spatial dimensions in a periodic and ordered way by simple translation. In turn, the crystal lattice is made up of smaller structures called unit cells, each of which is made up of a series of atoms arranged on the vertices, faces or center of a virtual “box”. In order for a crystal to exhibit the piezoelectric effect, it is necessary for its structure to have no center of symmetry. A stress, for example a tensile or compressive one, applied to these types of crystals alters the separation between the sites containing the positive and negative charges in each unit cell, leading to a net polarization on the outer surfaces of the crystal. There is also the reversed phenomenon, so if the same crystal, instead of being subjected to a force, is exposed to an electric field it will undergo an elastic deformation that causes its length to increase or decrease, according to the polarity of the applied field. Crystals are intrinsically constituted by micro-domains, i.e. small-sized regions, in which the electric dipole moments are oriented in the same way due to mutual interactions of electric type among the ions of the lattice that tend to align according to precise directions. Due to the random orientation of the domains within the material, the resulting polarity in a crystal is zero. In order to achieve piezoelectric properties it is therefore necessary to apply an external electric field according to a process commonly referred to as poling. The application of a constant electric field, under known temperature and time conditions, allows the alignment of the dipoles of the individual domains along preferential directions which result in a total net dipole and thus no longer zero polarity. Since a piezoelectric crystal has a high dielectric constant, once the applied electric field is removed, the dipole moment remains nearly unchanged.

Therefore, according to the above, the first piezoelectric layer 9 constitutes a second pole of the luminous device 3, whereas, as mentioned above, the supporting layer 8, advantageously made of metal, constitutes the first pole, where the first pole and the second pole are connected to the aforesaid light sources by the aforesaid first electric cable and the aforesaid second electric cable.

It should be added that the second electric cable 11 is combined with the first piezoelectric layer 9 preferably by tin soft soldering, thus practically constituting the other electrode (second electrode) of the luminous device 3.

According to the invention, as depicted in the example of FIG. 2, in the luminous device 3, two out of three light sources 5 denoted by 14 and 15 are arranged with a given electrical polarity, whereas one light source 16 out of three light sources 5 is arranged in the luminous device 3 with an opposite electrical polarity with respect to the aforesaid given electrical polarity.

In compliance with the above, generally speaking, it can therefore be said that in the luminous device according to the present invention n-m light sources, with m≥1, are arranged with a given electrical polarity and m light sources are arranged with an opposite electrical polarity with respect to the aforesaid given electrical polarity.

In practice, according to the invention, the arrangement of the light source 16 with opposite electrical polarity with respect to the light sources 14 and 15 results in the former being turned on when the potential difference generated by the piezoelectric system has opposite sign with respect to the potential difference that causes the light sources 14 and 15 to be turned on.

In other words, according to the present invention, it is possible to exploit the potential difference generated by the piezoelectric system to turn on the light sources of the luminous device both when the piezoelectric system undergoes an elastic mechanical stress, and therefore the potential difference at the ends of the piezoelectric system has positive sign, for example, and when the piezoelectric system returns to the initial configuration once the mechanical stress is over, and therefore the potential difference at the ends of the piezoelectric system has negative sign, for example. This is advantageous in that it allows the electric power produced to be used even after the mechanical stress the piezoelectric system is subjected to has ceased.

The above is consistent with the definition of electrical polarity, which is defined as the property of an electrified body or apparatus to have electrical charges of positive and negative signs at opposite ends or on two electrodes.

As regards to the electrical connection of the first electric cable and the second electric cable to the aforesaid light sources, there is to be said that the first electric cable and the second electric cable are electrically connected to the light sources preferably by soldering, more preferably by tin soft soldering.

In particular, if there are three light sources as in the example of FIG. 1, the first electric cable 10 is combined with the light source 15 and the second electric cable 11 is combined with the light source 14. Furthermore, the light sources 14 and 15 are directly electrically connected to each other via a further electric cable or further first piece of second electric cable 11a, the light source 15 is directly electrically connected to the light source 16 via a further electric cable or further second piece of second electric cable 11b, and the light source 14 is directly electrically connected to the light source 16 via a further electric cable or further first piece of first electric cable 10a.

In compliance with the above, it is therefore possible to connect the electric cables of the present luminous device to the light sources, regardless of the total number of the latter, according to preferred diagrams, that is depending on the number of the light sources having a given polarity and the number of the light sources having an opposite polarity with respect to the aforesaid given polarity.

According to the invention it should also be added that the luminous device 3 is without electrical battery or cell.

As illustrated in the example of FIG. 1, there is to be added that the luminous device according to the present invention preferably comprises a first element 17 placed on a first side of the piezoelectric system 6, and a second element 18 placed on a second side of the piezoelectric system 6 opposite the aforesaid first side, wherein the first element 17 and the second element 18 are, in a use layout, substantially in contact with the piezoelectric system 6. In this respect, it should be noted that in the aforesaid example of FIG. 1, in order to make the illustration more understandable, the first element 17 and the second element 18 are shown not in the position of use.

The first element 17 and the second element 18 constitute, in practice, a support for the piezoelectric system 6 and a striker for transmitting stresses to the piezoelectric system 6, respectively, and in fact the second element 18 transfers the stress caused, for example, by the weight force that a user's foot discharges on the rear part of the sole 2 to the piezoelectric system 6, which rests on the first element 17.

In practice, in use, the second element, the piezoelectric system and the first element are stacked one on top of the other in this order, starting from the position closest to a user's foot, as shown in the examples of FIGS. 3-10 which illustrate some embodiment variations of the first element and the second element, between which the piezoelectric system 6 comprising the supporting layer 8 and the first piezoelectric layer 9 and on which a force F acts, for example the aforementioned weight force, is also illustrated.

In particular, in the examples of the aforesaid FIGS. 3-10, some preferred embodiments of the first element and the second element with first piezoelectric layer 9 proximal to the second element are shown, about which it is to be mentioned that, according to the invention, at least one of the first element and the second element and preferably both of them comprise at least two portions having hardness different from each other.

In detail, the example of FIG. 3 shows a first element 117 and a second element 118 each comprising two portions having hardness different from each other, wherein the aforesaid two portions denoted by 117a, 117b and 118a and 118b, respectively, are one inside the other and are substantially circular and concentric to each other, even though portions with different hardness having elliptical shape or other shapes could be provided as well. In practice, according to the above, a first element and/or a second element of the aforesaid type can be provided, each having a central portion partially or completely surrounded by a peripheral portion, regardless of their respective shapes, in which the central portion and the peripheral portion have hardness different from each other.

It should be added that, according to the present invention, the greater or lesser hardness of the aforesaid two portions having hardness different from each other is reversed, for corresponding portions, between the first element 117 and the second element 118.

Therefore, according to the above, the hardness of the inner portion 117a of the first element 117 is lower than the hardness of the outer portion 117b of the same first element 117, while the hardness of the inner portion 118a of the second element 118 is higher than the hardness of the outer portion 118b of the second element 118.

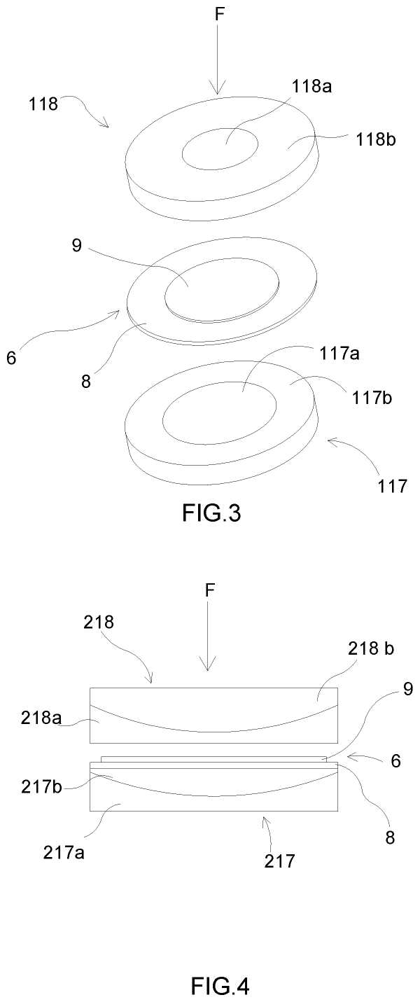

The example of FIG. 4 shows a first element 217 and a second element 218 each comprising two portions having hardness different from each other, wherein the aforesaid two portions denoted by 217a, 217b and 218a and 218b, respectively, are arranged one above the other and have complementary shapes, one portion having a convex side, the other portion having a concave side in contact with the aforesaid convex side.

Also in this case, according to the present invention, the greater or lesser hardness of the aforesaid two portions having hardness different from each other is reversed between the first element 217 and the second element 218, as regards portions corresponding to each other.

Thus, the hardness of the lower, concave-sided portion 217a of the first element 217 is greater than the hardness of the upper, convex-sided portion 217b of the same first element 217, while the hardness of the lower, concave-sided portion 218a of the second element 218 is less than the hardness of the upper, convex-sided portion 218b of the second element 118.

Therefore, in compliance with the above and according to the present invention, generally speaking, it can be said that in the first element and/or in the second element comprising two portions arranged one above the other, the portion having higher hardness is preferably arranged distal from the piezoelectric system and the portion having lower hardness is preferably arranged proximal to the piezoelectric system.

Moreover, as regards the materials, it should be said that in the aforesaid first element and/or the aforesaid second element, the portion with lower hardness preferably consists of ethylene vinyl acetate (EVA) with hardness preferably between 40 and 65 Asker C, and that in the aforesaid first element and/or the aforesaid second element, the aforesaid portion with higher hardness preferably consists of polyamide, ethylene vinyl acetate (EVA) or rubber preferably with hardness of at least about 75 Shore A.

A second element having the features illustrated above with reference to the example of FIG. 4 is particularly advantageous as it allows to have a hardness gradient increasing towards the center of the second element, while still having a soft material in direct contact with the first piezoelectric layer and therefore preserving the integrity of the latter in particular in case of stresses F characterized by a particularly high impulse, that is to say stresses characterized by a great strength and a short duration.

A first element having the features illustrated above with reference to the example of FIG. 4 is particularly advantageous in that it provides a hardness gradient which decreases towards the center of the first element and which works in synergy with the gradient of the second element. Such an embodiment is advantageous also in that it allows to reduce the variety of materials used to make the first element and the second element, while achieving substantially the same result of embodiments in which the first element and/or the second element comprise more than two portions having hardness different from each other, as it will better understood hereafter.

The example of FIG. 5 shows a first element 317 and a second element 318 each comprising a central portion 317a and 318a, respectively, and a pair of side portions each denoted by 317b and 318b, respectively, between which the respective central portion 317a and 318a is included, wherein the central portion and the side portions have hardness different from each other.

Also in this case, according to the present invention, the greater or lesser hardness of the portions having hardness different from each other is reversed between the first element 317 and the second element 318, as regards corresponding portions.

Therefore the hardness of the central portion 317a of the first element 317 is lower than the hardness of the side portions 317b of the same first element 317, whereas the hardness of the central portion 318a of the second element 318 is higher than the hardness of the side portions 318b of the same second element 318.

According to the above, the central portion 317a of the first element 317 allows the deformation of the piezoelectric system 6 subjected to stress to be contained within a certain limit, in order to prevent the same piezoelectric system 6, and in particular the first piezoelectric layer 9, from being damaged by cracking or breaking, for example, while the side portions 317b have the purpose of containing the overall deformation of the first element 317 thus preventing it from collapsing and ensuring that it maintains an overall size substantially unchanged over time, the latter being required for the correct operation of the luminous device 3.

According to the above, the central portion 318a of the second element 318 allows the stress to be concentrated predominantly at the center of the piezoelectric system 6; this way, the deformation of the piezoelectric system 6 takes on the highest value so that the electric power produced, which is directly proportional to the deformation value of the piezoelectric system 6, also takes on the highest value, while the side portions 318b have the purpose of cushioning the stress and therefore decreasing the deformation far from the center of the piezoelectric system 6, thereby actually contributing to maximizing the electric power generated. In this regard, the deformation limit of the first piezoelectric layer 9, useful for determining the hardness of the aforementioned central and side portions, can be easily determined from tabulated values provided by the manufacturers of the piezoelectric systems of the aforementioned type. In this respect, piezoelectric systems of the type considered here are normally available on the market and are produced, for example, by Physik Instrumente (PI) GmbH & Co. KG, Auf der Roemerstrasse 1, 76228 Karlsruhe-Germany.

In practice, due to the hardness difference between the side portions and the central portion of the first element and the hardness difference between the side portions and the central portion of the second element it is possible to maximize, at the same stress, the deformation of the first piezoelectric layer 9 compared to a first element and a second element each having substantially homogeneous hardness, and consequently it is possible to maximize the electric power produced, which is directly proportional to the deformation at the same stress. This way, the piezoelectric system 6 becomes extremely sensitive to stresses, i.e., it generates a current sufficient to turn on the light sources 5 even under minimal stresses.

Still according to the example of FIG. 5, it should be said that the first element 317 and the second element 318 preferably have the same shape, for example a quadrangle-based shape, and preferably the same dimensions, for example a thickness of about 1.5 mm, although shapes and dimensions different from those indicated above may be provided for the first element and/or the second element. For example, the thickness of the first element and/or the second element may be increased depending on the thickness of the sole 2.

In any case, it is advantageous to provide the first element and the second element with the same shape and dimensions, in particular as regards width and length, since this allows the first element, the second element and the piezoelectric system to be made as a single pre-assembled piece.

Still in accordance with the example of FIG. 5 it should be said that each of the side portions 318b of the second element 318 has width greater than the width of each of the side portions 317b of the first element 317 by an amount d≥1 mm, thereby reducing the width of the central portion 318a of the second element 318 with respect to the width of the central portion 317a of the first element 317. This is advantageous since it allows to focus the stresses transmitted to the piezoelectric system 6 on a smaller surface, the one of the central portion 318a, at the first piezoelectric layer 9, thereby increasing the deformation of the latter and therefore the electric power produced.

As illustrated in the example of FIG. 5, the portions having different hardness of the first element and the second element also are quadrangle-base shaped.

As regards the materials, it should be said that the first element and the second element preferably consist of polymeric material and, in particular, it should be said that the central portion 317a of the first element 317 and/or the side portions 318b of the second element 318 preferably consist of ethylene vinyl acetate (EVA) having hardness preferably between 40 and 65 Asker C, and the side portions 317b of the first element 317 and/or the central portion 318b of the second element 318 preferably consist of polyamide, ethylene vinyl acetate (EVA) or rubber having hardness of at least about 75 Shore A.

It should also be added that the first element 317 and the second element 318 can be made, for example, by cutting and subsequent joining, for example by gluing, the central portions 317a and 318a to the respective side portions 317b and 318b, or they can be made by molding or extrusion. Methods of making the first element and/or the second element, as stated above, may be used for all embodiment variations of the present invention and thus for all different embodiments of the first element and the second element.

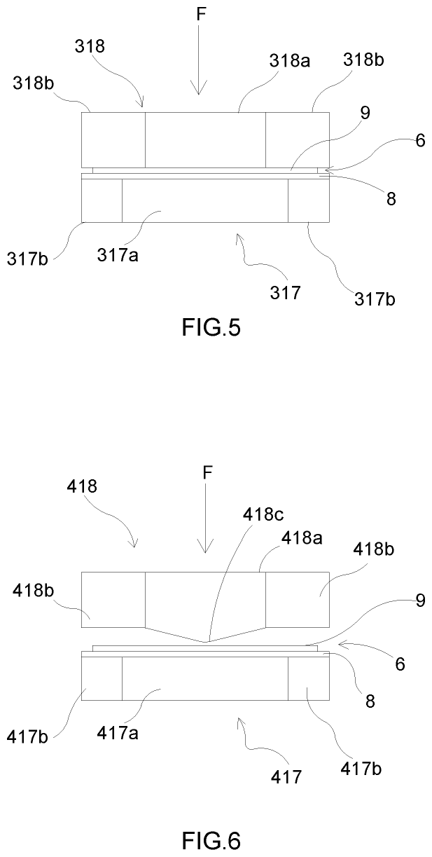

What has been set forth above with reference to the example in FIG. 5, unless otherwise specified also applies to the example in FIG. 6, in which a second element 418 having a central portion 418a included between side portions 418b is shown, wherein the central portion 418a has a substantially truncated-cone profile, on the side of the second element 418 substantially in contact with the piezoelectric system 6. Basically, the central portion 418a is provided with a protrusion 418c having truncated-cone shape. This feature allows the response of the piezoelectric system 6 to be sped up since a minimal change of the stress F applied on the second element 418 results in a deformation of the piezoelectric system 6 sufficient to generate a potential difference to power the luminous device 3. The example of FIG. 6, in addition to the second element 418 and the piezoelectric system 6, also shows a first element 417 comprising a central portion 417a included between side portions 417b, for which applies what has been previously described for the first element 317 of the example of FIG. 5.

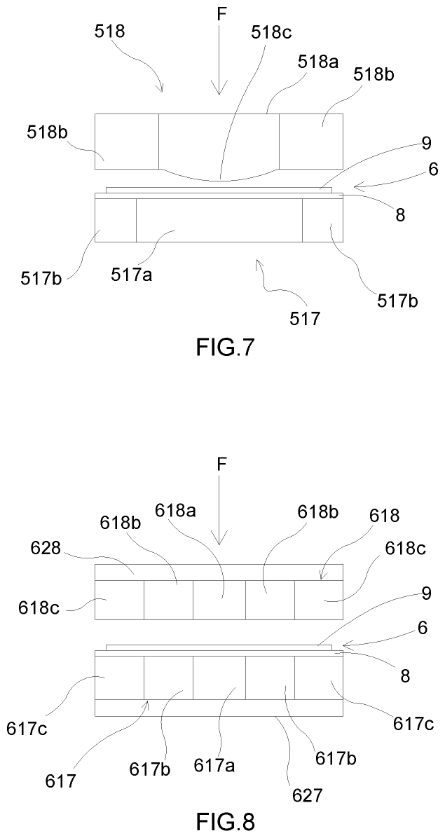

What has been set forth above with reference to the example in FIG. 5, unless otherwise specified also applies to the example in FIG. 7, in which a second element 518 having a central portion 518a included between side portions 518b is shown, wherein the central portion 518a has a substantially spherical-cap profile, on the side of the second element 518 substantially in contact with the piezoelectric system 6.

Basically, the central portion 518a is provided with a protrusion 518c having spherical-cap shape. This feature, compared to the embodiment illustrated in the example of FIG. 6, allows the stress F to be more uniformly distributed on the piezoelectric system 6 and particularly on the first piezoelectric layer 9, thereby making the latter less likely to be damaged especially when it consists of an inherently fragile ceramic material. The example of FIG. 7, in addition to what has been described above, also shows a first element 517 comprising a central portion 517a included between side portions 517b, for which applies what has been previously described for the first element 317 of the example of FIG. 5.

What has been set forth above with reference to the example in FIG. 5, unless otherwise specified also applies to the example in FIG. 8, in which a first element 617 and a second element 618 are shown each comprising, in addition to a central portion 617a and 618a, respectively, included between a pair of side portions each denoted by 617b and 618b, respectively, a pair of peripheral portions each denoted by 617c and 618c, respectively, between which the pair of side portions 617b and 618b, respectively, are included, in which in the first element 617 and in the second element 618 the respective peripheral portions 617c and 618c, the respective side portions 617b and 618b and the respective central portion 617a and 618a have hardness different from each other.

In particular, in the second element 618, the hardness of the peripheral portions 618c is lower than the hardness of the side portions 618b whose hardness, in turn, is lower than the hardness of the central portion 618a. This allows a hardness gradient increasing towards the central portion 618a of the second element 618 to be obtained, so that the stress F is transmitted in an almost unchanged way at the central portion 618a but is instead progressively damped towards the side portions 618b and the peripheral portions 618c. Also in this embodiment, the amount of the greatest deviation of the first piezoelectric layer 9 from the undeformed geometry is obtained at the central portion 618a of the second element 618. It should be noted that, compared to the embodiments illustrated in the examples of FIGS. 6 and 7, in this case the second element 618 is substantially entirely in contact with the first piezoelectric layer 9. This minimizes, or even removes, discontinuities between the second element 618 and the first piezoelectric layer 9, which could locally cause too high deformations that could lead the first piezoelectric layer 9 to break, especially when the latter consists of an inherently fragile ceramic material. In other words, since the second element 618 is almost entirely in contact with the first piezoelectric layer 9, it provides the latter with an almost continuous support thanks to the contact forces developed between the two.

According to the above, the greater or lesser hardness of the portions having hardness different from each other is reversed with regards to corresponding portions of the first element 617 and the second element 618.

Therefore, in the first element 617, the hardness of the peripheral portions 617c is greater than the hardness of the side portions 617b whose hardness, in turn, is greater than the hardness of the central portion 617a. This way, a hardness gradient decreasing towards the central portion 617a of the first element 617 is achieved, which works in synergy with the second element 618.

As regards the materials, it should be said that the central portion 617a of the first element 617 and/or the peripheral portions 618c of the second element 618 preferably consist of ethylene vinyl acetate (EVA) having hardness between 40 and 65 Asker C, the peripheral portions 617c of the first element 617 and/or the central portion 618a of the second element 618 preferably consist of polyamide, ethylene vinyl acetate (EVA) or rubber having hardness of at least about 75 Shore A, and the side portions 617b of the first element 617 and/or the side portions 618b of the second element 618 preferably consist of polyamide, ethylene vinyl acetate (EVA) or rubber having hardness that is intermediate between the hardness of the respective peripheral portions and the hardness of the respective center portion.

According to the invention, the present luminous device may further comprise a support for the first element and/or a support for the second element.

According to the example depicted in FIG. 8, the luminous device in compliance with the present invention comprises a first support or lower support denoted by 627 combined with the first element 617 and a second support 628 or upper support combined with the second element 618.

In particular, the first element 617 rests on the first support 627 which is rigid and prevents both the first element 617 from uncontrollably yield, possibly one or more of the portions of the first element 617 having different hardness from partially yield, that could make the piezoelectric system 6 less efficient or even damage it.

Additionally, the second support 628 that rests on the second element 618 is rigid and allows the stress F to be transmitted in an almost unaltered manner, thereby maximizing the efficiency of the piezoelectric system 6.

It should be added that, according to further embodiment variations of the present invention, only one of the first element and the second element may have all of the features described with reference to the example of FIG. 8, the other of the first element and the second element being able to have either only some of the features described with reference to the example of FIG. 8 or the features illustrated with reference to the examples of FIG. 5, 6 or 7. Similarly, a first support and/or a second support of the aforesaid type may also be provided in the embodiments illustrated above with reference to the examples in FIGS. 3-7.

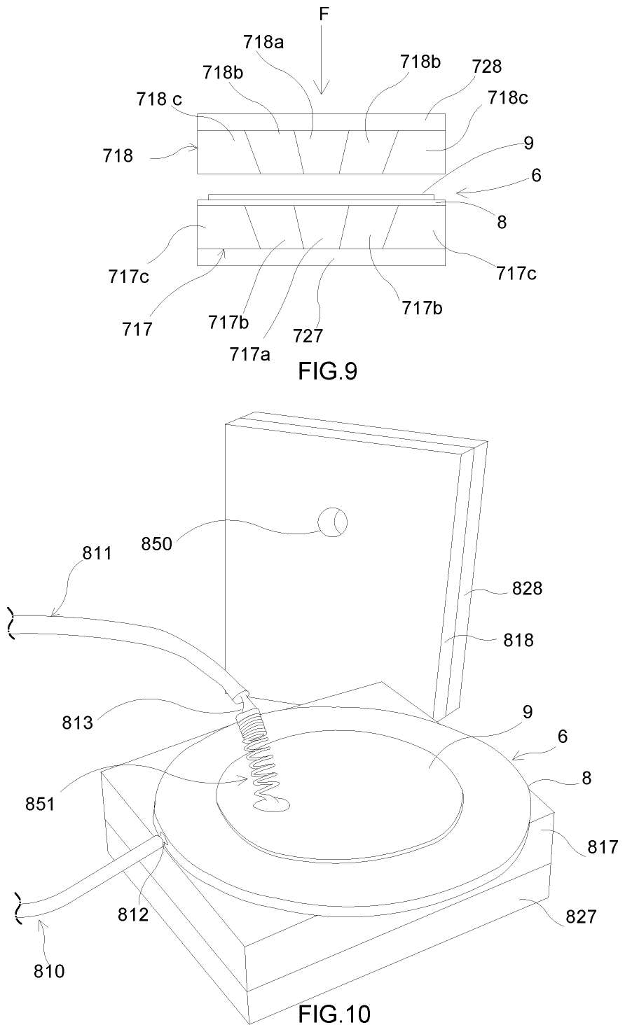

The example of FIG. 9 shows a configuration very similar to that illustrated in the example of FIG. 8, which the reader should refer to, except for the fact that in the first element and in the second element, the portions having hardness different from each other have surfaces in mutual contact with each other inclined with respect to an axis perpendicular to the piezoelectric system 6, preferably by an angle between about 2° and about 30°.

Therefore, the example of FIG. 9 shows a first element 717 and a second element 718, each comprising a central portion 717a and 718a, respectively, included between a pair of side portions each denoted by 717b and 718b, respectively, and a pair of peripheral portions each denoted by 717c and 718c, respectively, between which the pair of side portions 717b and 718b, respectively, is included, to which what is set forth above with reference to the example of FIG. 8 applies and wherein, as mentioned, the surfaces of mutual contact between the different portions, that is, between the portions having hardness different from each other, are inclined with respect to an axis perpendicular to the piezoelectric system 6. This configuration is advantageous because it increases the contact surface between the different portions that make up the first element and the second element, thereby increasing their mutual adhesion and therefore making the first element and the second element particularly stable from a dimensional point of view, even after several loading and unloading cycles.

A first support 727 combined with the first element 717 and a second support 728 combined with the second element 718 to which what described above for the first support and the second support of the example of FIG. 8 applies, are also described in the example of FIG. 9.

In compliance with the present invention and according to the above, between the surfaces of mutual contact between the portions having different hardness an angle having size as set forth above may be provided in only one of the first element and the second element, and furthermore it should be said that, in the first element and/or the second element previously described with reference to the examples of FIGS. 5-7, an inclination of the mutual contact surfaces as set forth above may also be provided.

The example in FIG. 10 depicts a detail of a luminous device according to a further embodiment variation of the present invention.

In detail, the example of FIG. 10 shows a piezoelectric system 6 comprising a supporting layer 8 and a first piezoelectric layer 9 very similar to the piezoelectric system previously illustrated, which the reader should refer to, which is arranged between a first element 817 constrained to a first support 827 and a second element 818 constrained to a second support 828, wherein only the first element 817 is shown in contact with the piezoelectric system 6, the second element 818 being shown not stacked in the example of FIG. 10.

The first element 817 and/or the second element 818 may have the features of any one of the embodiments described above with reference to the examples of FIGS. 1 and 3-9 with respective variations and, in addition, the second element 818 and the second support 828 are provided with a through hole 850 to electrically connect the first piezoelectric layer 9 to the connecting means of the luminous device according to the present invention.

In this regard, the example of FIG. 10 also shows part of the aforesaid connecting means to electrically connect the piezoelectric system 6 to the light sources of the luminous device according to the present invention, the aforesaid connecting means in accordance with the above comprise a first electric cable 810 having a first end 812 combined with the supporting layer 8 by soldering, preferably by tin soft soldering, and a second electric cable 811 having a first end 813 electrically connected to the first piezoelectric layer 9, wherein the aforesaid connecting means further comprise an elastic element 851 interposed between the first piezoelectric layer 9 and the first end 813 of the second electric cable 811, wherein the elastic element 851 engages the through hole 850.

Preferably the aforesaid elastic element 851 is a metal spring through which the second electric cable is connected to the first piezoelectric layer by soldering, preferably by tin soft soldering, and which limits, thanks to its damping capacities, the stresses weighing on the soldering, in this case on the soldering constraining the first piezoelectric layer to the second electric cable.

It should be added that, in the embodiments described with reference to the examples of FIGS. 1 and 3-9 with variations thereof, an elastic element of the aforesaid type and/or a second element equipped with a through hole and/or tin-based soldering as considered above can also be provided.

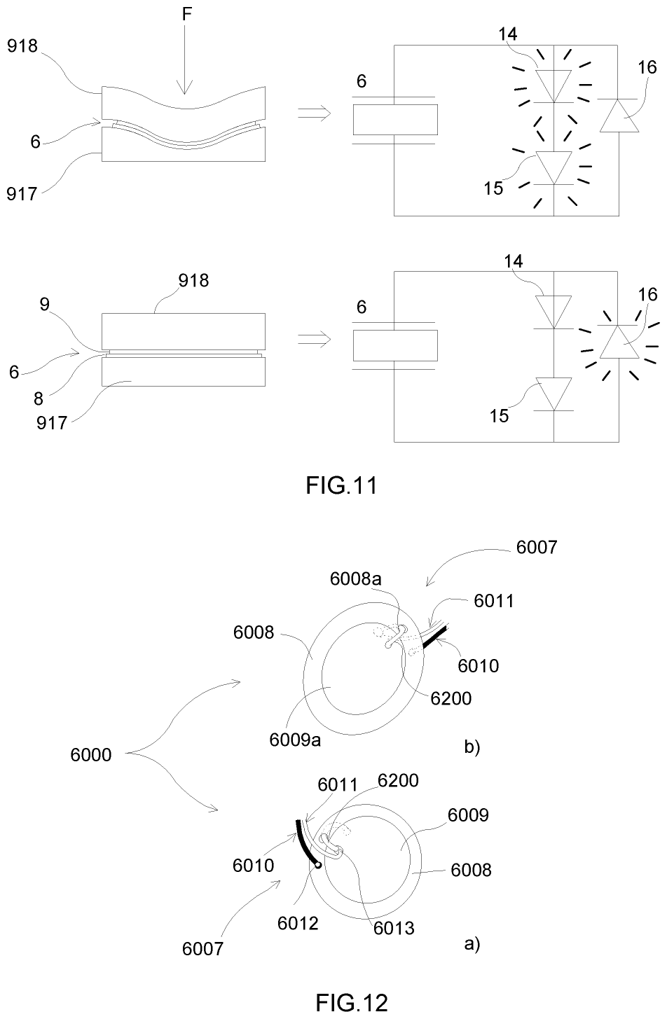

The example of FIG. 11 shows the operation of the luminous device according to the present invention and in particular shows the piezoelectric system 6 comprising the supporting layer 8 and the first piezoelectric layer 9, which are both included between a first element 917 and a second element 918 according to the embodiments of the examples of FIGS. 3-9 and variations thereof.

In the example of FIG. 11, a stress directed from top to bottom is also denoted by F and is constituted, for example, by the weight force the user's foot discharges on a sole provided with the present luminous device. The effect of the application of the aforesaid stress F and the effect of the removal thereof are depicted in the respective wiring diagrams of the luminous device according to the present invention shown in FIG. 11, in line with what has been described above with reference to the example of FIGS. 1 and 2, which the reader should refer to.

Conveniently, the first piezoelectric layer 9 is placed above the supporting layer 8: this is particularly advantageous when the first piezoelectric layer 9 consists of a ceramic material since this type of material resists well to compression but has lower tensile resistance; the just-described configuration allows the stress F to be turned into a compressive stress instead of a tensile stress.

It should be highlighted that the operation of the luminous device according to the present invention is illustrated by exaggerating the deformation of the first element 917, the second element 918 and the piezoelectric system 6. Anyway, the application of a stress F causes the piezoelectric system 6 to deform thus generating a potential difference at the ends of the electrodes of the luminous device and, consequently, the turn-on of the light sources 14 and 15, as illustrated in the respective wiring diagram. Conversely, the removal of the stress F causes the elastic recovery of the piezoelectric system 6 to the initial configuration, thereby generating a potential difference of opposite sign to the previous one and the consequent turn-on of the light source 16, as illustrated in the respective wiring diagram of FIG. 11.

In compliance with further embodiment variations, the piezoelectric system of the luminous device according to the present invention may comprise a second piezoelectric layer combined with the supporting layer on the opposite side with respect to the first piezoelectric layer, wherein the second piezoelectric layer is preferably the same as the first piezoelectric layer and, as the latter, it is in practice constrained to the supporting layer thus forming a sandwich structure.

A piezoelectric system comprising a first and a second piezoelectric layer as described above is illustrated in the example of FIG. 12 that shows, partially in phantom view, a piezoelectric system 6000 having a circular supporting layer 6008 shown from a first side in which the first, also circular, piezoelectric layer 6009 is visible (view a), and from a second side in which the second, also circular, piezoelectric layer 6009a is visible (view b).

In the example of FIG. 12, connecting means 6007 to electrically connect the piezoelectric system to the light sources of the luminous device are also partially shown.

In this respect it should be noted that, in this case, both the first and the second piezoelectric layers are electrically connected through the aforesaid connecting means to the light sources which, instead, are not shown in the example of FIG. 12, and moreover, similarly to what previously described, also the supporting layer 6008 is electrically connected through the aforesaid connecting means 6007 to the light sources of the luminous device. For this purpose, in accordance with the above, the connecting means 6007 comprise a first electric cable 6010 having a first end 6012 combined with the supporting layer 6008 by soldering, preferably by tin soft soldering, a second electric cable 6011 having a first end 6013 combined with the first piezoelectric layer 6009 by soldering, preferably by tin soft soldering, and a third electric cable 6200 extended between the first piezoelectric layer 6009 and the second piezoelectric layer 6009a and combined with the former by soldering, preferably by tin soft soldering and more preferably at the electrical connection (soldering) of the first end 6013 of the second electric cable 6011.

In detail, as illustrated in the example of FIG. 12, in order to connect the third electric cable 6200 with both the first piezoelectric layer 6009 and the second piezoelectric layer 6009a, the supporting layer 6008 is provided with a hole 6008a through which the third electric cable 6200 passes, the latter remaining insulated from the supporting layer 6008 thanks to its own insulating sheath which is usually provided in the electric cables, as known, although the supporting layer can however be provided without a through hole and a path of the third electric cable can run around the supporting layer, rather than therethrough.

In practice, the third electric cable 6200, which actually extends between two soldering provided on the first piezoelectric layer and on the second piezoelectric layer, can be considered as a further length (piece) of the second electric cable 6011 and in particular as an extension of the second electric cable 6011 on the side thereof that includes the aforesaid first end 6013.

This embodiment allows the electric power produced by the piezoelectric system 6000 to be increased.

In a variation of this embodiment not shown in the examples of the figures, a third electric cable extending between a portion of the second electric cable distal from the first piezoelectric layer and the second piezoelectric layer may be provided, in practice as a branch of the second electric cable. That is, in this case, the third electric cable branches off from the second electric cable or may be considered as a branch thereof, wherein the third electric cable has a respective first end electrically connected to the second piezoelectric layer by soldering, preferably by tin soft soldering.

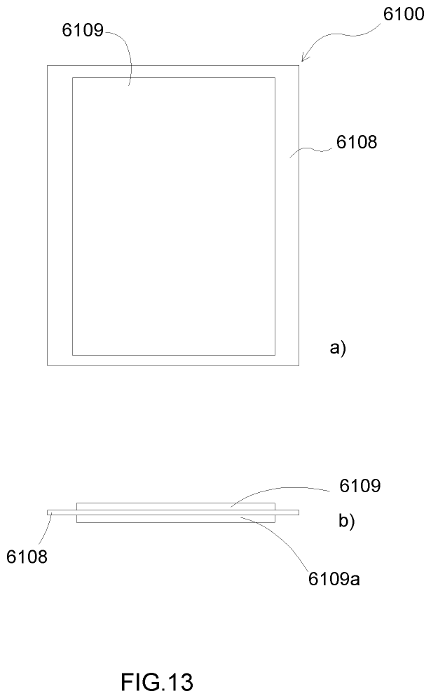

A further embodiment of a piezoelectric system having two piezoelectric layers of a luminous device for a sole structure according to the present invention is shown in the example of FIG. 13. In such an embodiment, a piezoelectric system 6100 comprises a first piezoelectric layer 6109 and a second piezoelectric layer 6109a and a supporting layer 6108 included between them, for all of which what set forth above applies unless otherwise specified.

In this case, both the piezoelectric layers and the supporting layer are shaped as rectangles, whose dimensions are between about 24 mm by about 17 mm and between about 26 mm by about 23 mm, respectively. The thickness of the supporting layer 6108 is about 0.25 mm. It should be said, however, that these dimensions can also be implemented in piezoelectric systems with a single piezoelectric layer, as described above. Therefore, in general, as shown in the examples of the figures, it is to be said that in all embodiments of the present invention, the extent of the piezoelectric layer or layers is less than the extent of the supporting layer.

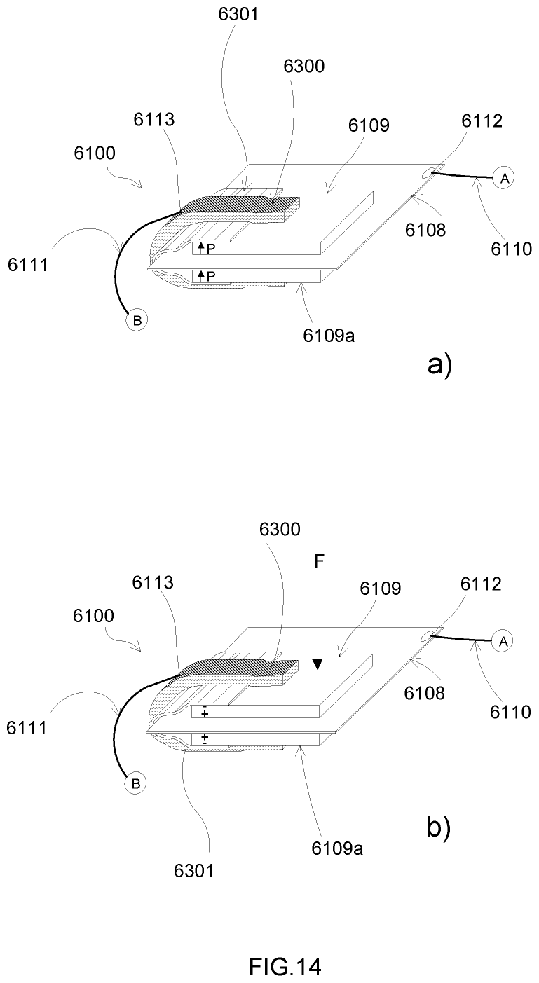

The example of FIG. 14 shows a further embodiment of the present invention in which a luminous device comprises a piezoelectric system having two piezoelectric layers as described above.

In detail, FIG. 14 shows a partial schematic view of a luminous device comprising a piezoelectric system 6100 shown, so to speak, at rest (view a)) and during its use (view b)).

In particular, the piezoelectric system 6100 comprises a first piezoelectric layer 6109 and a second piezoelectric layer 6109a and a supporting layer 6108 included between them, for all of which what described above applies unless otherwise specified.

The example of FIG. 14 also partially shows the connecting means to connect the piezoelectric system to the light sources which, on the other hand, in the example of FIG. 14 are not shown.

In this regard, the connecting means comprise a first electric cable 6110 having a first end 6112 electrically connected, preferably by soldering, more preferably by tin soft soldering, to the supporting layer 6108 and a second electric cable 6111 having a first end 6113 electrically connected to the piezoelectric layers. For this purpose, the aforesaid connecting means also comprise a conducting element 6300 in contact with both the first piezoelectric layer 6109 and the second piezoelectric layer 6109a, and an insulating element 6301 interposed between the conducting element 6300 and the supporting layer 6108, wherein the first end 6113 of the second electric cable 6111 is combined with the conducting element 6300, preferably by soldering, more preferably by tin soft soldering, while the conducting element 6300 is prevented from contacting the supporting layer 6108 of the piezoelectric system 6100 by the insulating element 6301. In practice, the terminals or terminal lengths of the first electric cable 6110 and the second electric cable 6111, in the example of FIG. 14 denoted by A and B, constitute the poles A (first pole) and B (second pole), respectively, of the piezoelectric system, and therefore of the luminous device according to the present invention, at the ends of which a potential difference is generated, whose sign depends on the stress (tensile or compressive) acting on the piezoelectric system.

This way, the first piezoelectric layer and the second piezoelectric layer are arranged in parallel, with concordant polarization as indicated by the arrows “P” in the example of FIG. 14 view a). The “polarity” of the first piezoelectric layer 6109 and the second piezoelectric layer 6109a means the polarity caused by the alignment of the dipoles as a result of the above-described poling process. This way, the application of a stress F directed as in the example of FIG. 14 view b), puts the first piezoelectric layer 6109 under compression and the second piezoelectric layer 6109a under tension thereby causing the accumulation of positive and negative charges as indicated respectively by the symbols “+” and “−”.

Therefore, the pole B becomes the negative pole while the pole A becomes the positive pole. When the compressive stress ends, the first piezoelectric layer 6109 and the second piezoelectric layer 6109a return to a neutral state, and during this transition there is a reversal of the sign of the voltage at the ends of the poles A and B.

With regard to further features of the conducting element 6300 and the insulating element 6301, it is to be said that the latter practically consists of a layer of insulating material comprising a first insulating portion and a second insulating portion which are arranged on the first piezoelectric layer 6109 and the second piezoelectric layer 6109a, respectively, wherein the first insulating portion and the second insulating portion consist of a single strip preferably of insulating adhesive tape, thus making the implementation of the luminous device according to the present invention particularly simple.

Also the conducting element 6300 in practice comprises a first conducting portion placed above the first insulating portion and at least partially in contact with the first piezoelectric layer, and a second conducting portion placed above the second insulating portion and at least partially in contact with the second piezoelectric layer, wherein the first conducting portion and the second conducting portion are made as a single monolithic piece, preferably a strip of conductive adhesive tape, more preferably a tape of the aforesaid type comprising copper wires or strips, thus making the implementation of the luminous device according to the present invention particularly simple.

Preferably, the extent of the insulating element 6301, i.e. the first insulating portion and the second insulating portion, is as small as possible and sufficient to prevent the first and second conducting portions, therefore the conducting element 6300, from contacting the supporting layer 6108. For example, the first insulating portion and the second insulating portion have just to cover the first piezoelectric layer and the second piezoelectric layer, respectively, by about 0.5-1 mm.

On the other hand, preferably, the extent of the first conducting portion and the second conducting portion, thus of the conducting element 6300, is as large as possible; this way, any possible fragments of the first piezoelectric layer and/or the second piezoelectric layer are held together, thus preventing them from dispersing thereby damaging the piezoelectric system and/or partially or completely decreasing the efficiency thereof.

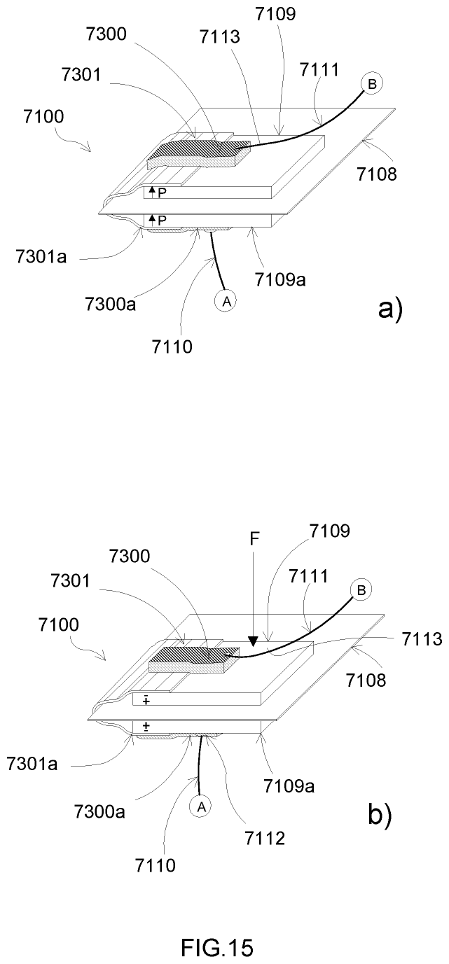

What has been described above with reference to the example in FIG. 14, unless otherwise specified also applies to the example of FIG. 15 that shows a further embodiment of the present invention in which a luminous device comprises a piezoelectric system having two piezoelectric layers as described above.

In detail, FIG. 15 shows a partial schematic view of a luminous device comprising a piezoelectric system 7100 shown, so to speak, at rest (view a)) and during its use (view b)).

In particular, the piezoelectric system 7100 comprises a first piezoelectric layer 7109 and a second piezoelectric layer 7109a and a supporting layer 7108 included between them, for all of which, unless otherwise specified, applies what described above.

The example of FIG. 15 also partially shows the connecting means to connect the piezoelectric system to the light sources which, on the other hand, in the example of FIG. 15 are not shown.

In this regard, the connecting means comprise a first electric cable 7110 having a first end 7112 electrically connected to the second supporting layer 7109a and a second electric cable 7111 having a first end 7113 electrically connected to the first piezoelectric layers 7109.

For this purpose, the aforesaid connecting means preferably further comprise a first conducting element 7300 in contact with the first piezoelectric layer 7109 and a second conducting element 7300a in contact with the second piezoelectric layer 7109a, wherein the first conducting element and the second conducting element are electrically insulated from each other so as not to create a short circuit, and wherein the first end 7112 of the first electric cable 7110 is combined with the second conducting element 7300a, preferably by soldering, more preferably by tin soft soldering, while the first end 7113 of the second electric cable 7111 is combined with the first conducting element 7300, preferably by soldering, more preferably by tin soft soldering.

In practice, the terminals or terminal lengths of the first electric cable 7110 and the second electric cable 7111, in the example of FIG. 15 denoted by A and B, constitute the poles A (first pole) and B (second pole), respectively, of the piezoelectric system, and therefore of the luminous device according to the present invention, at the ends of which a potential difference is generated, whose sign depends on the stress (tensile or compressive) acting on the piezoelectric system.

This way, the first piezoelectric layer and the second piezoelectric layer are arranged in series, i.e. with discordant polarization, as indicated by the arrows “p” in the example of FIG. 15 view a). The “polarity” of the first piezoelectric layer 7109 and the second piezoelectric layer 7109a means the polarity caused by the alignment of the dipoles as a result of the above-described poling process.

This way, the application of a stress F directed as in the example of FIG. 15 view b), puts the first piezoelectric layer 7109 under compression and the second piezoelectric layer 7109a under tension thereby causing the accumulation of positive and negative charges as indicated respectively by the symbols “+” and “−”.

Therefore, the pole B becomes the negative pole while the pole A becomes the positive pole. When the compressive stress ends, the first piezoelectric layer 7109 and the second piezoelectric layer 7109a return to a neutral state, and during this transition there is a reversal of the sign of the voltage at the ends of the poles A and B.

According to the example of FIG. 15, the connecting means further comprise a first insulating element 7301 interposed between the first conducting element 7300 and the first piezoelectric layer, and a second insulating element 7301a interposed between the second conducting element and the second piezoelectric layer. As an alternative, a single insulating element basically obtained by joining the first insulating element and the second insulating element, can be provided, or else the insulating element or elements can be omitted, paying attention, as mentioned above, that the first conducting element and the second conducting element do not come into contact with the supporting layer.

The embodiment of the example of FIG. 14 can be compared to two in-parallel voltage generators, while the embodiment of the example of FIG. 15 can be compared to two in-series voltage generators: in the first case the current flowing through a load circuit connected to the poles A and B is higher than in the second case, while for the voltages the opposite happens. This means, for example, that the same load circuit consisting for example of a LED light source is brighter in the first case than in the second.

In accordance with the above, luminous devices made according to the examples of FIGS. 14 and 15, which as mentioned illustrate details of the present invention, may also comprise a first element and a second element of the type described above, and may comprise, as well, a first support and a second support of the type described above which preferably are present in all embodiments of the present invention. Such supports, in fact, also allow to “normalize” in a single direction the stress acting on the piezoelectric system, thus preventing that stress components acting on more than one direction occur—circumstance which could take place, for example, since the sole of a shoe, where the luminous device according to the present invention can be inserted, is relatively soft and could transmit almost simultaneously in more directions stresses generated by almost simultaneous impacts or bending—which could totally or partially cancel each other thus causing the light sources not to turn on.

In accordance with the present invention, preferred strength values for the piezoelectric system are 10000 compression cycles with an applied load of 400 N, corresponding to the weight force generated by a body weighing about 40 kg, at a frequency of 1 Hz and a load application speed of 200 mm/min.

It should also be noted that, according to the present invention, it is also possible to invert the aforesaid first element and the aforesaid second element with each other, i.e. with the second element placed further away from the user's foot than the first element. In this case, with an embodiment comprising only one piezoelectric layer (first piezoelectric layer) and first element and second element having at least two portions having hardness different from each other, the same piezoelectric layer is maintained preferably proximal to the second element, as in the non-inverted configurations, so that it can work mainly under compression.

The advantages of the present invention, which have become clear during the above description, can be summarized by pointing out that a sole structure for luminous footwear, as well as the respective luminous footwear, comprising a luminous device which is self-powered by exploiting the movement of the human body without the need for a battery, is provided.

A further advantage lies in the sensitivity of the luminous device according to the present invention, which is able to operate even when the applied stress has minimal values.

Further advantages lie in the reliability, cost-effectiveness and extended service life of the luminous device according to the invention.

Further advantages lie in the possibility to use known technologies to implement both the sole structure comprising the luminous device according to the present invention and the respective luminous footwear comprising the aforesaid sole structure, and in the freedom of implementing the same, which allows to obtain innumerable models of luminous footwear, sole structure and luminous devices with different luminous patterns.

In this regard it should be noted that, according to the invention, the light sources of the luminous device may be placed all at the sole, or all at the upper, or they may be split partly at the sole and partly at the upper of luminous footwear.

In order to meet contingent and specific requirements, several variations and modifications could be made by a field technician to the illustrated and described embodiments of present invention, provided that all are included in the scope of protection of the invention as defined by the following claims.

1. A self-powered luminous device, comprising:
n light sources, with n≥2,
a piezoelectric system comprising at least one supporting layer and at least one first piezoelectric layer combined with each other, and
connecting means to electrically connect said piezoelectric system to said light sources, wherein said connecting means comprise a first electric cable and a second electric cable which have respective first ends electrically connected to said piezoelectric system,
wherein n-m light sources, with m≥1, are arranged in said luminous device with a given electrical polarity and m light sources are arranged in said luminous device with an opposite electrical polarity with respect to said given electrical polarity, and
wherein said luminous device is without electrical battery.

2. The device according to claim 1, wherein said at least one first piezoelectric layer is made of a ceramic material selected from the group comprising lead zirconate titanate (PZT) and aluminum nitride (AlN) crystals.

3. The device according to claim 1, wherein said at least one supporting layer is made of a metal material, preferably brass.

4. The device according to claim 1,
wherein said first ends of said first electric cable and said second electric cable are electrically connected to said at least one supporting layer and to said at least one first piezoelectric layer, respectively,
wherein preferably said connecting means comprise an elastic element interposed between said at least one first piezoelectric layer and the first end of said second electric cable, and
wherein more preferably said elastic element is a metal spring.

5. The device according to claim 1, wherein said piezoelectric system comprises a second piezoelectric layer combined with said at least one supporting layer on the opposite side with respect to said at least one first piezoelectric layer.

6. The device according to claim 5, wherein said connecting means comprise a third electric cable, wherein said third electric cable is extended between said at least one first piezoelectric layer, preferably at the electrical connection of said first end of said second electric cable, and said second piezoelectric layer, or wherein said third electric cable branches off from said second electric cable and has a respective first end electrically connected to said second piezoelectric layer.

7. The device according to claim 5, wherein said connecting means comprise a conducting element in contact with both said at least one first piezoelectric layer and said second piezoelectric layer, and an insulating element interposed between said conducting element and said at least one supporting layer, wherein said first ends of said first electric cable and said second electric cable are combined with said at least one supporting layer and said conducting element, respectively.

8. The device according to claim 5, wherein said first ends of said first electric cable and said second electric cable are electrically connected to said second piezoelectric layer and said at least one first piezoelectric layer, respectively, wherein preferably said connecting means comprise a first conducting element and a second conducting element which are interposed between said at least one first piezoelectric layer and the first end of said second electric cable and between said second piezoelectric layer and the first end of said first electric cable, respectively.

9. The device according to claim 1, comprising a first element placed on a first side of said piezoelectric system, and a second element placed on a second side of said piezoelectric system opposite said first side, wherein said first element and said second element are substantially in contact with said piezoelectric system, wherein said first element and said second element constitute a support for the piezoelectric system and a striker for transmitting stresses to the piezoelectric system, respectively.

10. The device according to claim 9, wherein at least one of said first element and said second element comprises at least two portions having hardness different from each other.

11. The device according to claim 10, wherein said at least two portions are one inside the other, wherein preferably said at least two portions are substantially circular and concentric with each other, or wherein said at least two portions are placed one above the other with a complementary shape, one with a convex side, the other with a concave side in contact with said convex side.

12. The device according to claim 10, wherein at least one of said first element and said second element comprises a central portion and a pair of side portions between which said central portion is included, wherein the central portion and the side portions have hardness different from each other, wherein preferably at least one of said first element and said second element comprises a pair of peripheral portions between which said pair of side portions is included, wherein the peripheral portions, the side portions and the central portion have hardness different from each other.

13. The device according to claim 12, wherein said central portion of said second element has a substantially truncated-cone or spherical-cap profile, on the side of said second element substantially in contact with said piezoelectric system.

14. The device according to claim 10, wherein said at least two portions having hardness different from each other, have surfaces in mutual contact with each other inclined with respect to an axis perpendicular to said piezoelectric system, preferably by an angle between about 2° and about 30°.

15. The device according to claim 10, wherein the greater or lesser hardness of said at least two portions having hardness different from each other is reversed between said first element and said second element.

16. The device according to claim 10, comprising at least one support combined with either said first element or said second element, and preferably comprising a first support and a second support with which said first element and said second element are combined, respectively.

17. A sole structure for luminous footwear, comprising a sole and at least one luminous device according claim 1, combined with said sole.

18. A luminous footwear comprising a sole structure according to claim 17 and an upper combined with said sole, wherein the light sources of said luminous device are combined with said sole and/or said upper.
